(19) United States
(12) Patent Application Publication
(10) Pub. No.: US 2024/0386416 A1
(43) Pub. Date: Nov. 21, 2024

(54) KEY DEVICE AND SUPPLEMENTAL INTERFACE USE

(71) Applicant: Block, Inc., San Francisco, CA (US)

(72) Inventors: Alexander Schoof, Leesburg, VA (US); Max Guise, Albuquerque, NM (US); Arvin Amanpour, New York, NY (US)

(73) Assignee: Block, Inc., San Francisco, CA (US)

(21) Appl. No.: 18/666,155

(22) Filed: May 16, 2024

Related U.S. Application Data
(60) Provisional application No. 63/467,190, filed on May 17, 2023.

(51) Int. Cl. G06Q 20/36

(52) U.S. Cl. CPC G06Q 20/3672

(57) ABSTRACT

Key device and supplemental interface use is described as part of enabling digital transaction involving a transfer of one or more cryptographic tokens. In one or more examples, transaction details are received from an edge device that are proposed for a transfer of one or more cryptographic tokens as part of a digital transaction. A communication is formed for display by a supplemental interface associated with an address that is to participate in the transfer. A confirmation is received from the supplemental interface that the transfer of the one or more cryptographic tokens is permitted and a signed authorization is generated confirming the transaction details using at least one cryptographic key. The signed authorization is transmitted for receipt by a key device that is configured to determine that the signed authorization originated from the wallet server and is configured to participate in the transfer as part of the digital transaction.

### RELATED APPLICATIONS

This application claims priority under 35 U.S.C. Section 119 (e) to U.S. Provisional Patent Application No. 63/467,190, filed May 17, 2023, and titled “Wallet Hardware Key Device and Supplemental Display Use,” attorney docket number SQ-1773-PR1, the entire disclosure of which is hereby incorporated by reference.

### TECHNICAL FIELD

Cryptocurrency addresses such as blockchain addresses, oftentimes have one or more private keys that can be used to sign transactions for asset transfer from the address. Because the private key allows an entity to spend the assets within the wallet, private keys are often secured in hardware or software wallets.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

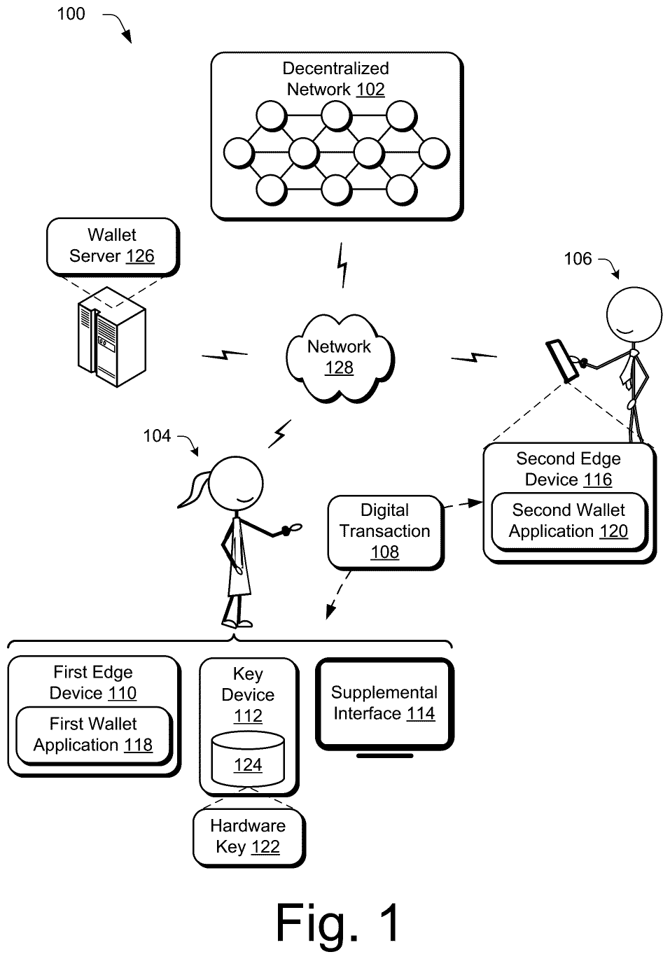

FIG. 1 is a block diagram of a non-limiting example environment of key device and supplemental interface use as described herein in accordance with one or more implementations.

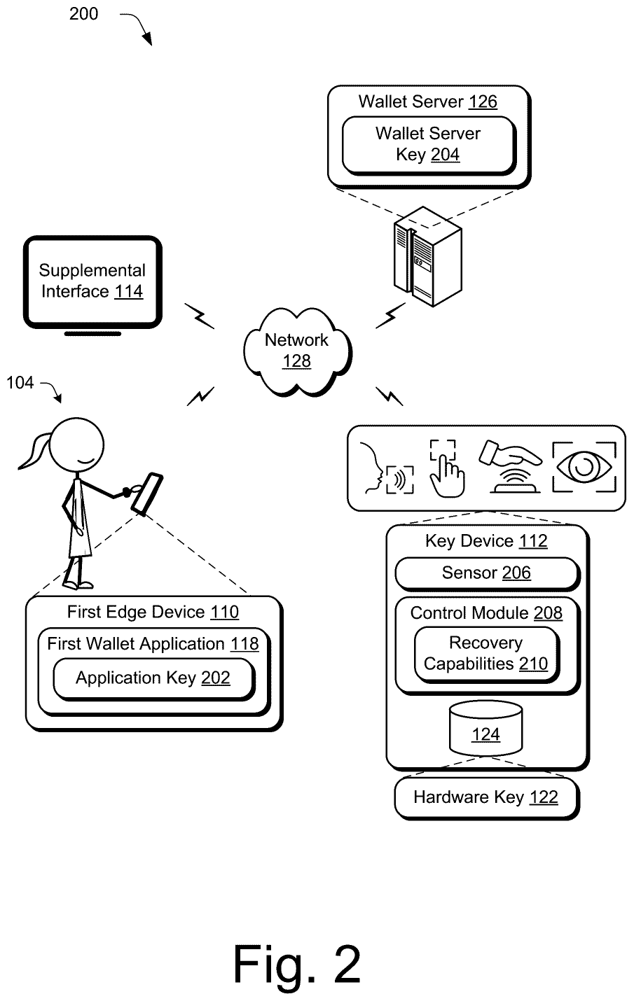

FIG. 2 is a block diagram of a non-limiting example environment showing operation of devices associated with a first entity of FIG. 1 in greater detail in accordance with one or more implementations.

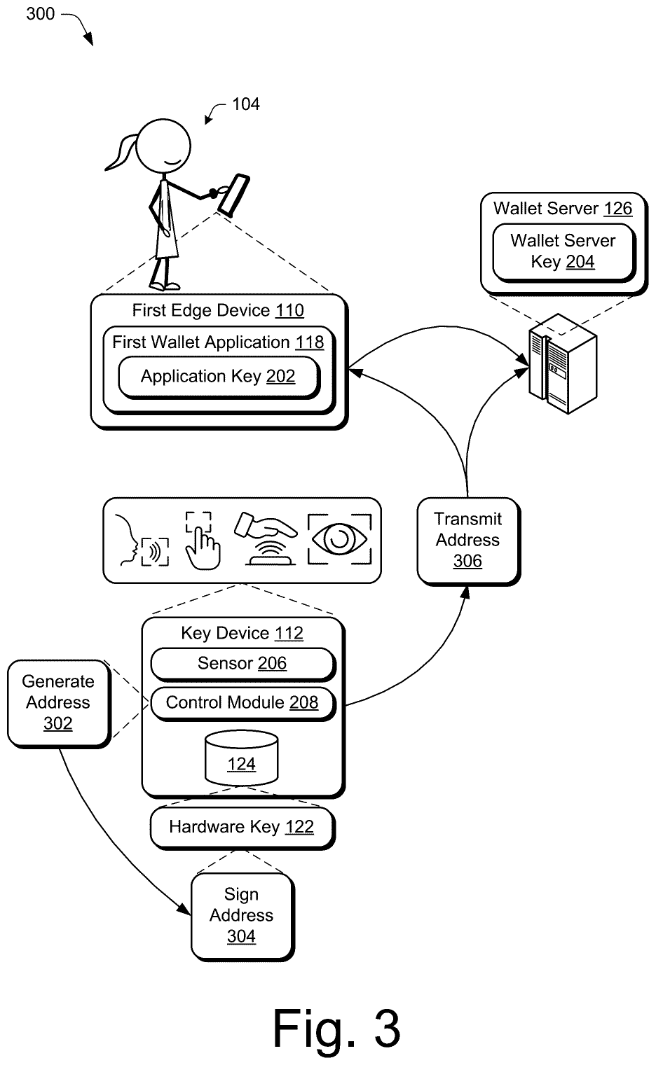

FIG. 3 is a block diagram of a non-limiting example environment showing operation of devices associated with a first entity of FIG. 1 that includes a key device and a first edge device in greater detail as generating transaction details and transmitting the transaction details in accordance with one or more implementations.

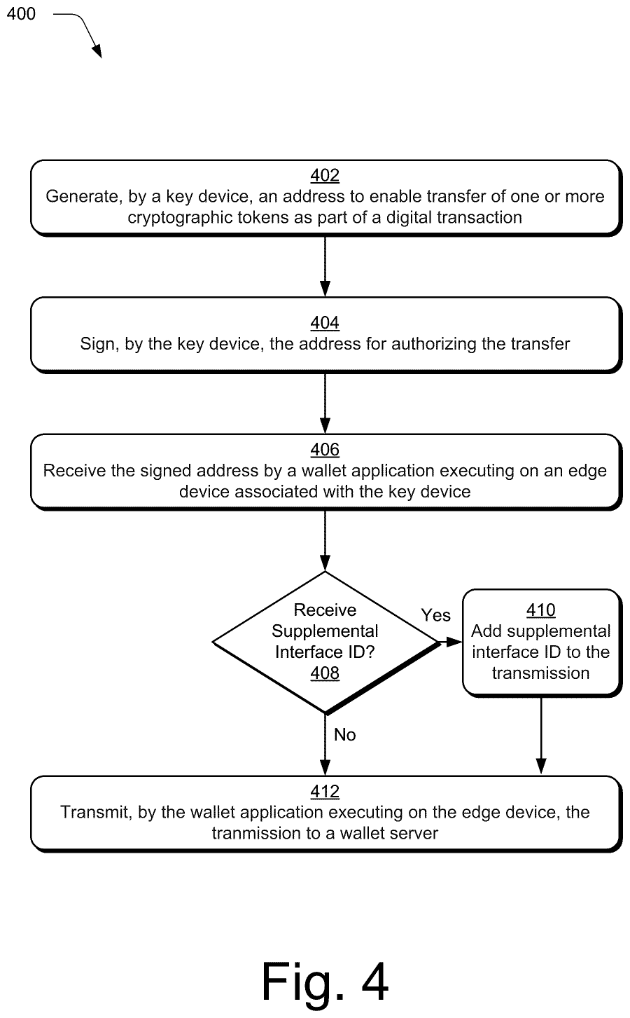

FIG. 4 is a flow diagram depicting a step-by-step procedure in an example implementation of operations performable by a processing device for accomplishing a result of entry of details of a digital transaction involving a transfer of cryptographic tokens by a key device and transfer of those details to a wallet server.

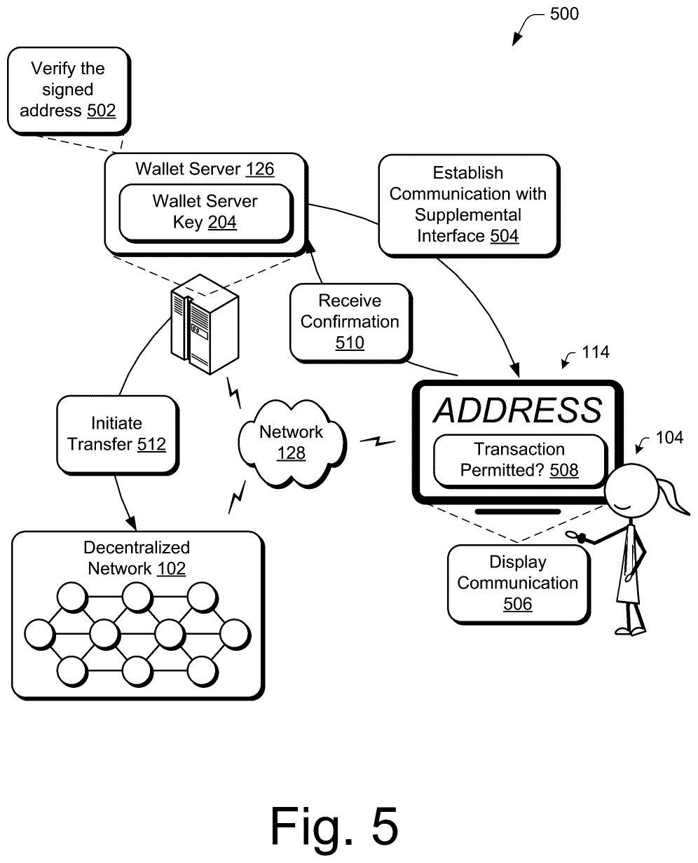

FIG. 5 is a block diagram of a non-limiting example environment showing receipt by a wallet server of the transaction details of FIG. 3 and initiation of a transfer of cryptographic tokens as part of a digital transaction responsive to confirmation by a supplemental interface in accordance with one or more implementations.

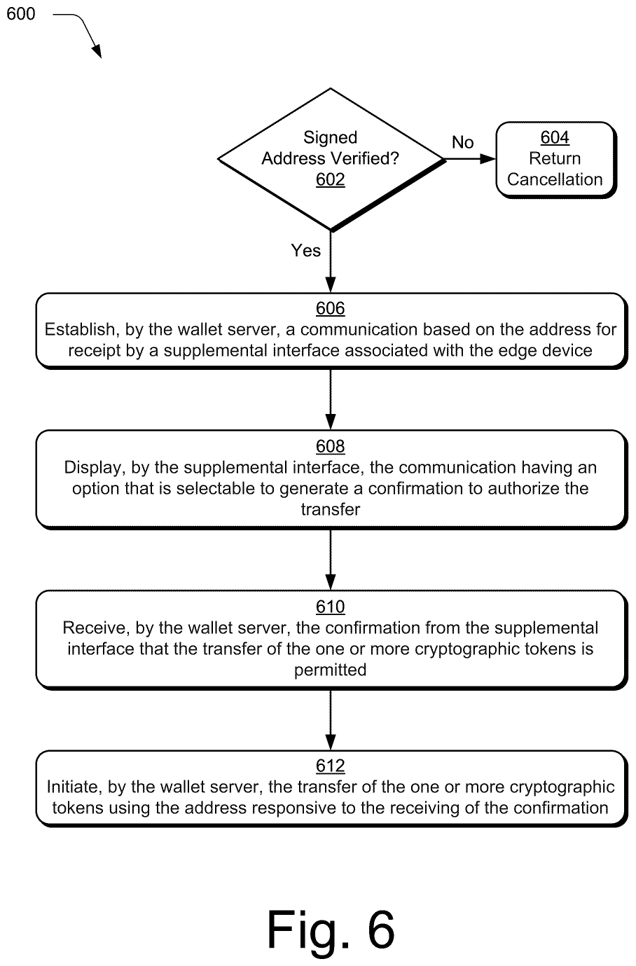

FIG. 6 is a flow diagram depicting a step-by-step procedure in an example implementation of operations performable by a processing device for accomplishing a result of initiation of a transfer of cryptographic tokens responsive to receipt of a confirmation from a supplemental interface in accordance with one or more implementations.

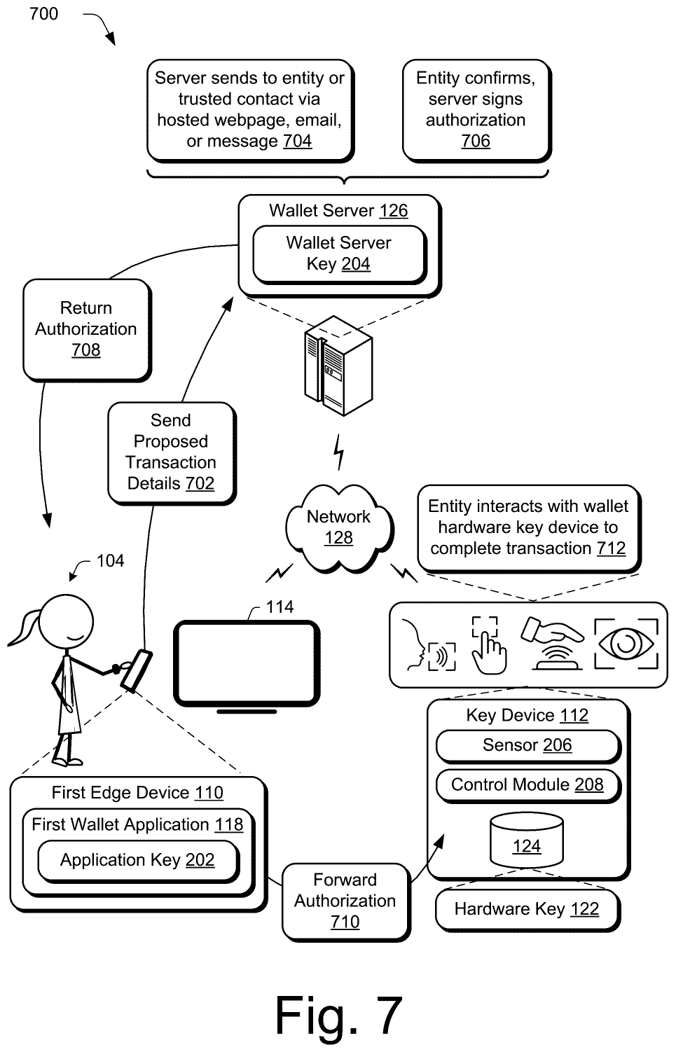

FIG. 7 is a block diagram of a non-limiting example environment showing generation of transaction details on an edge device and confirmation of the details by a supplemental interface for initiating a digital transaction involving a transfer of cryptographic tokens accordance with one or more implementations.

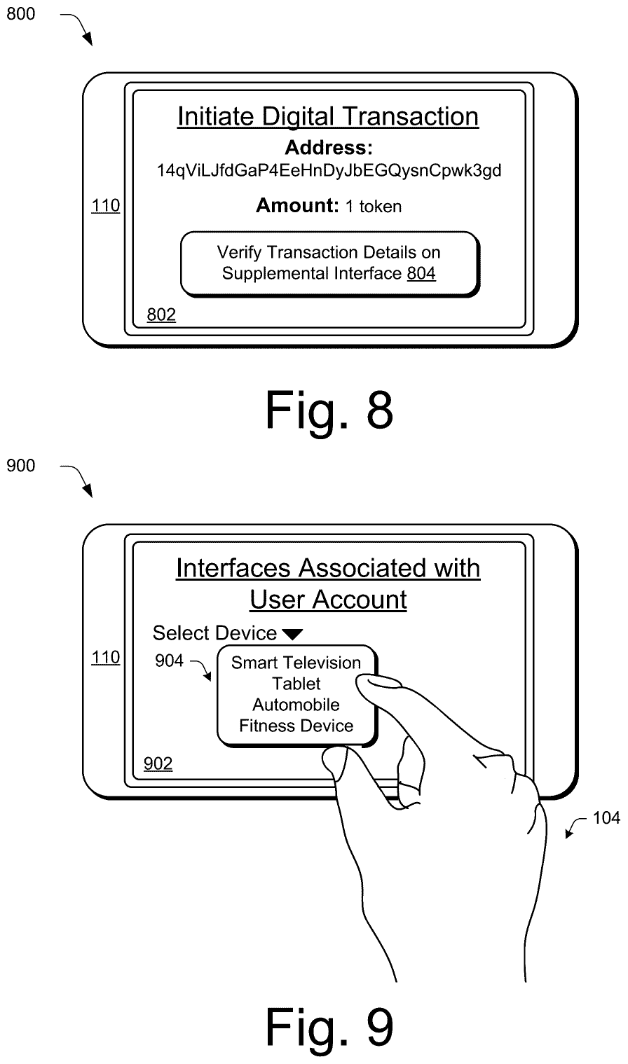

FIG. 8 depicts an example implementation showing output of a user interface by the first edge device in support of entry of transaction details in accordance with one or more implementations.

FIG. 9 depicts an example implementation showing output of a user interface by the first edge device in support of entry of a supplemental interface that is to confirm transaction details accordance with one or more implementations.

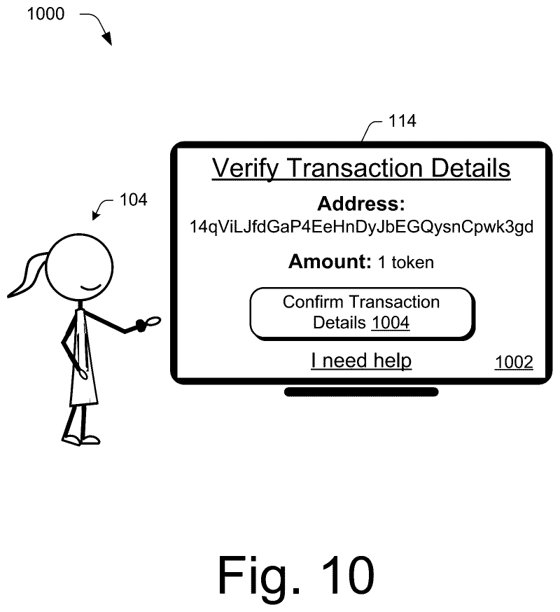

FIG. 10 depicts an example implementation showing output of a user interface by a supplemental interface as displaying transaction details and an option that is user selectable by the first entity to confirm transaction details accordance with one or more implementations.

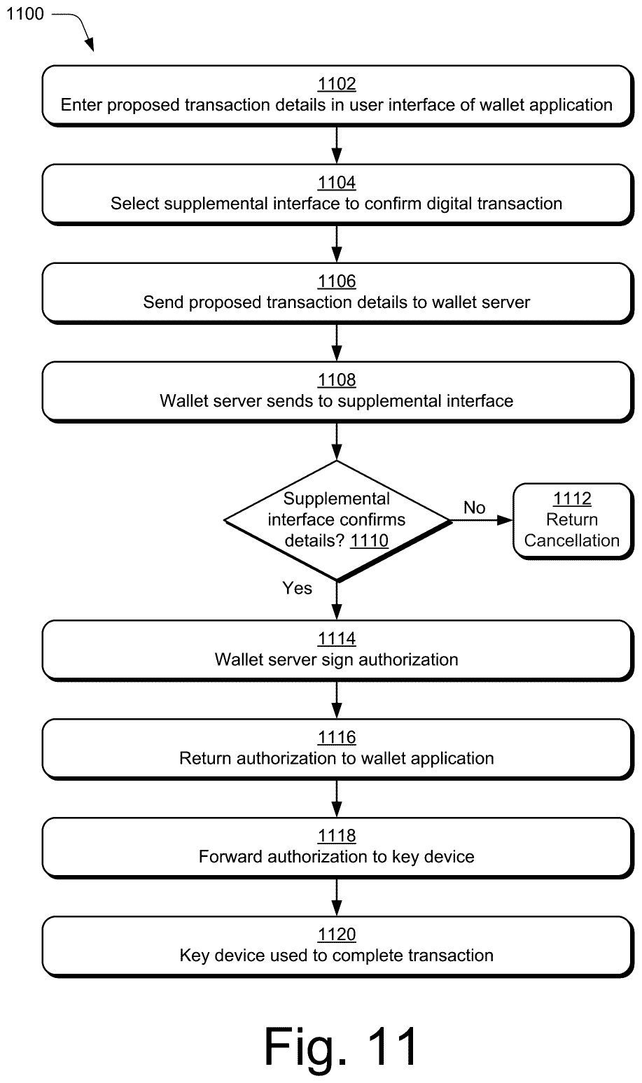

FIG. 11 is a flow diagram depicting a step-by-step procedure in an example implementation of operations performable by a processing device for accomplishing a result of initiation of a transfer of cryptographic tokens responsive to receipt of a confirmation from a supplemental interface responsive to generation of the transaction details by an edge device in accordance with one or more implementations.

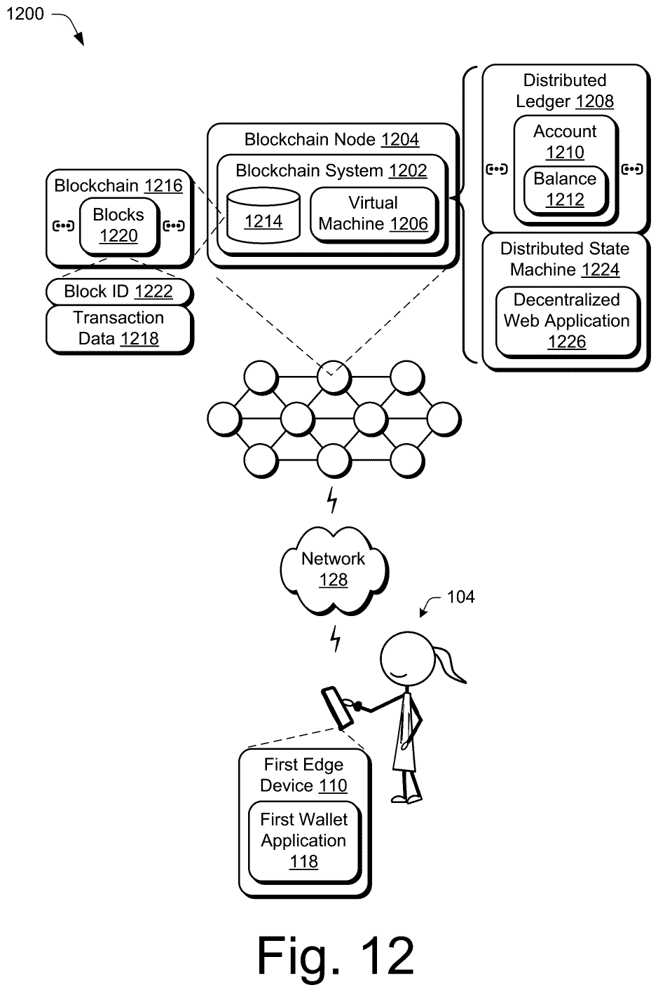

FIG. 12 is a non-limiting example showing operation of a blockchain node as part of a blockchain system of FIG. 11 in accordance with one or more implementations.

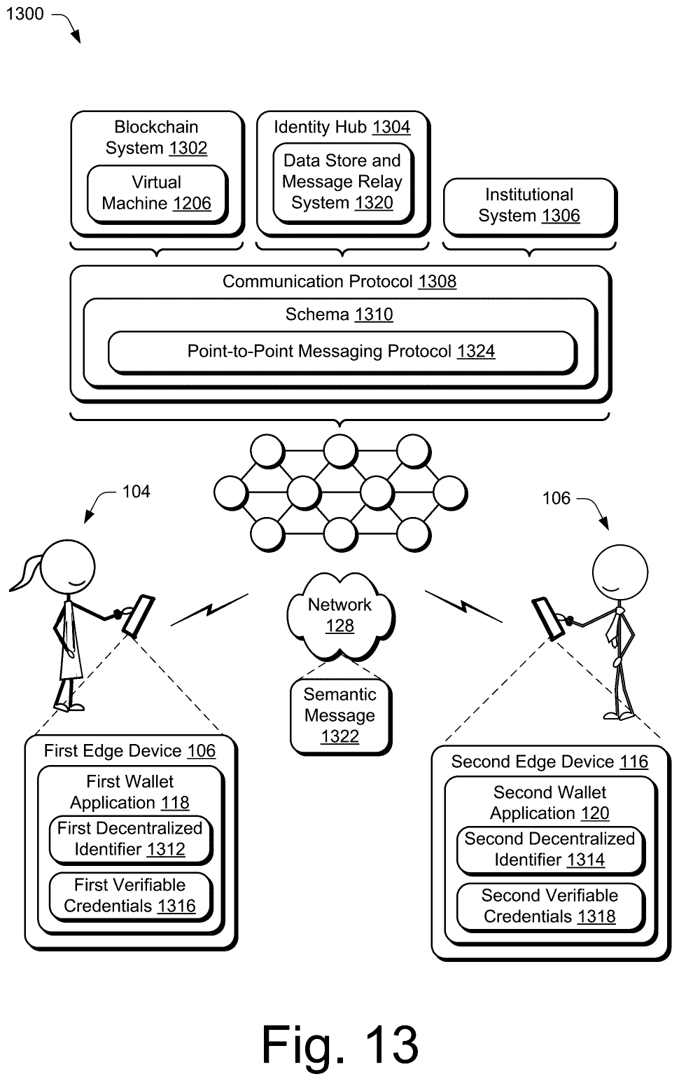

FIG. 13 is a non-limiting illustration of an example system that is operable to implement blockchain supported resource transfer communication protocol techniques described herein in accordance with one or more implementations.

### DETAILED DESCRIPTION

### Overview

Self-custody tools refer to techniques and devices to store, control, and manage cryptographic tokens in a safe and secure manner. Examples of self-custody tools include hardware or software wallets that store private keys, wallet applications that implement self-custody wallets, key devices that may be implemented using hardware to support cryptographic key storage, and so forth. Key devices, for instance, can add additional layers of security to a digital wallet through use of a sensor to uniquely identify an entity, and permit or restrict access to a cryptographic key (e.g., hardware key) maintained in an associated storage device through a control module. Key devices, for instance, are configurable as wallet hardware key devices that do not include a display device. In real-world scenarios, however, self-custody tools can be unfamiliar and appear complicated to casual entities (e.g., users) that have not gained specialized knowledge nor confidence in operation of these tools.

Among commonly accepted practices with hardware wallets is the use of relatively small hardware screens and buttons to mitigate attacks, often ineffectively. In practice, use of a hardware screens in real-world scenarios may involve squinting and peeking through prompt after prompt, comparing alphanumeric strings and other details between the screen on the hardware wallet and where the information is stored, typically offline on a paper. Hardware screens also add cost and complexity to a hardware wallet, that has a portable form factor. When this process results in a final decision to approve a transaction, the hardware wallet uses a respective private key to sign the transaction so that it will be accepted by a decentralized network (e.g., a blockchain network) onto the public ledger.

The irreversible nature of these transactions increases reliance on accurate verification as opposed to typical custodial banking transactions. For example, if the wrong inputs, such as addresses, are keyed on the screen or a wrong amount of funds is sent, the recipient has the sole resources to return the funds.

To address these and other technical challenges, techniques and systems are described that leverage use of a key device and supplemental display as part of transferring cryptographic tokens in a digital transaction. These techniques and systems support a comparison of details involved in the digital transaction (e.g., addresses, account names, amounts) using an independent device to protect against compromise by malicious parties. The comparison may be performed in a variety of ways. One or more initial examples involve use of a supplemental interface to confirm entry of the address and other details of the digital transaction as described in relation to FIGS. 3-6. One or more additional examples involve use of a supplemental interface to confirm entry by a wallet application which is then used to initiate a transfer by a key device as described in relation to FIGS. 7-11. The supplemental interface, for instance, is selectable by a wallet server (e.g., randomly) from a list of supplemental interfaces (e.g., devices) verified by the entity, a list of trusted contacts, and so forth.

In the one or more initial examples, an entity interacts with a key device (e.g., a hardware key device) and enters details of a digital transaction that is to involve transfer of one or more cryptographic tokens, e.g., to be received by the entity or transferred from the entity. The details may include an address that is to participate in the digital transaction, amount of cryptographic tokens involved in the transaction, and so forth. The address and other details are then signed by the key device for authorizing a transfer of cryptographic tokens. The key device maintains a database of which wallet application keys and server keys it can collaborate with to sign transactions, allowing the key device to generate a receive address without inputs from the wallet application.

The signed address is received from the key device at an edge device, e.g., a mobile phone associated with the entity. In an implementation, inputs are received at the edge device through execution of a wallet application that specifies a supplemental interface that is to be used to confirm the details. The supplemental interface, for instance, is selectable via a user interface using a dropdown menu or other functionality, e.g., an IP address or other “pairing” technique.

The details of the digital transaction (e.g., the signed address) are then transmitted by the wallet application executing on the edge device to a wallet server, e.g., via the internet. Other implementations are also contemplated in which the key device transmits the address and other details of the digital transaction directly to the wallet server.

The wallet server, upon receipt of the transmission, is configured to verify that the signed address originated from the key device. To do so, in one implementation, the wallet server checks as to whether the signed address is signed with the private key of the key device based on a comparison with a public key of the key device. In another implementation, the wallet server executes such checks by comparing with past transaction history involving the sending and receiving address, edge devices, and other such information. In yet another implementation, the wallet server may be instructed (e.g., by the user via the key device) to attest any transaction meeting certain attributes, e.g., above a certain amount or for a certain period, without any additional checks. Once verified, the wallet server establishes a communication with the supplemental interface associated with the edge device, which is encrypted. Continuing with the previous examples, the communication is transmitted based on identification of the supplemental interface at the edge device, through association with an account of the entity maintained at the wallet server (e.g., in support of direct communication between the key device and the wallet server), and so forth.

The supplemental interface displays the communication in a user interface. The communication includes a representation of the address that is to receive the cryptographic tokens, an amount of the cryptographic tokens, and so forth. The user interface also includes an option that is selectable to generate a confirmation to authorize the transfer. Selection of the option causes the supplemental interface to communicate the confirmation back to the wallet server.

The wallet server receives the confirmation from the supplemental interface, and in response, permits the transfer of the cryptographic tokens as part of the digital transaction using the address and other details. In this way, the supplemental interface is configurable to address technical challenges and protect against compromise by malicious parties, further discussion of which may be found in relation to FIGS. 3-6.

In one or more additional examples, a supplemental interface for a key device is used in support of a digital wallet to perform a digital transaction. The system further includes an edge device, a wallet server, and a key device. The edge device sends proposed transaction details to the wallet server, which then sends the details to a supplemental interface. The entity that is associated with the supplemental interface (e.g., owner or trusted contact) views the proposed transaction details and, if accurate, confirms the details. The web server then generates a signed authorization confirming the transaction details, which is sent to the edge device. The edge device forwards the signed authorization to the key device. Once the key device receives the authorization and verifies the authorization was sent from the web server (e.g., through public/private key verification), the key device enables completion of the digital transaction to transfer the cryptographic tokens. Thus, in this example a supplemental interface is used to confirm entry by a wallet application which is then used to initiate a transfer by a key device.

As described in each of the examples above, supplemental use of a display device in conjunction with a key device supports a variety of functionalities. In initial examples of FIGS. 3-6, for providing receive addresses to a sender either in person or via multiple platforms/channels that the sender can compare. In additional examples of FIGS. 7-11, for verifying outgoing transaction details, specifically on a device that was not used to supply the key device with the transaction details in the first place. Other examples are also described in the following sections for protecting against mobile malware from silently manipulating outgoing transaction parameters which is also not capable of sufficiently manipulating the phone's display.

For example, verification of the transaction may be performed on a server in which “stringified” text is sent to an edge device that is then transmitted into an application (e.g., hosted remotely). A user, for instance, initiates a transaction and signs the transaction using a key device, which is then sent to a wallet server. The wallet server signs the transaction and is returned to the edge device, which is then transmitted locally (e.g., “airdropped”) to a supplemental interface, which then communicates with a remotely executed application to verify. In another example, a user initiates a transaction and a supplemental interface is paired with a web server and shares a public key. The web application sends the transaction to the web server, which is encrypted. The supplemental interface is then used to confirm the transaction and send a confirmation back to the web server. The web server signs the transaction along with the signature. The key device is then used to validate and sign the transaction.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

FIG. 1 is a block diagram of a non-limiting example environment 100 of key device and supplemental display use as described herein in accordance with one or more implementations. The environment 100 includes a decentralized network 102, a first entity 104 and a second entity 106 that are to participate in a digital transaction 108, e.g., to transfer one or more cryptographic tokens via the decentralized network 102. The first entity 104 is associated with a variety of devices, illustrated examples of which include a first edge device 110, a key device 112, and a supplemental interface 114. The second entity 106 is depicted as associated with a second edge device 116.

Computing devices that implement the environment 100 and the devices within the environment 100 are configurable in a variety of ways. A computing device, for instance, is configurable as a server, a desktop computer, a laptop computer, a mobile device (e.g., assuming a handheld configuration such as a tablet or mobile phone), an IoT device, a wearable device (e.g., a smart watch), an AR/VR device, and so forth. Thus, a computing device ranges from full resource devices with substantial memory and processor resources to low-resource devices with limited memory and/or processing resources. Although in instances in the following discussion reference is made to a computing device in the singular, a computing device may also represent any number of different computing devices, such as multiple servers of a server farm utilized to perform operations “over the cloud” as further described below.

The first edge device 110 has executing thereon a first wallet application 118 and the second edge device 116 has executing thereon a second wallet application 120. The first and second wallet applications 118, 120 respectively, permit access to the decentralized network 102, e.g., a blockchain network and/or “layer 2” network that is built “on top” of a blockchain network as further described in relation to FIGS. 12 and 13.

The key device 112 is configurable to maintain a hardware key 122 in a storage device 124 that is local to the key device 112. The key device 112 is configurable to add additional layers of security to a digital wallet. The key device 112, for instance, is configurable to receive inputs that are usable to uniquely identify the first entity 104 to permit or restrict access to the hardware key 122 maintained in the storage device 124, e.g., as encrypted.

The environment 100 also includes a wallet server 126. The wallet server 126 is configurable by a third party separate from the first entity 104. The wallet server 126 supports functionality to interact with the decentralized network 102.

The wallet server 126, for instance, is configured to route the digital transaction 108 using the decentralized network 102 on behalf of the first and second entities 104 106, e.g., by cryptographically signing the digital transaction 108 and interacting with nodes of the decentralized network 102. A network 128 (e.g., the Internet) is illustrated as communicatively coupling the decentralized network 102, first edge device 110, second edge device 116, and/or wallet server 126, either directly or indirectly. The network 128 is also representative of one or more networks, e.g., local area networks, near field communication networks, the Internet, and so on. The key device 112, for instance, is communicatively coupled to the first edge device 110 locally (e.g., via near field communication) to communicate with the decentralized network 102 via the network 128.

In one implementation and in case of a transaction between a first user and a second user, the key device 112 can cryptographically sign information and the first edge device 110 can forward that signature to wallet server 126. The wallet server 126 compares the received signature against potential malware and stored information to verify the information was not modified in transit by the edge device, even if their edge device is compromised by malware. Conversely, the wallet server 126 can sign information that can be verified by key device, e.g., by comparing received information with stored information, ensuring that a compromised edge device didn not tamper with information sent from wallet server 126 to key device 112. With the ability to send data securely between wallet server 126 and key device 112, the present methods and systems potentially use the server to do something the hardware cannot in one or more implementations: communicate detailed transaction information like destination address, fees, and amounts directly to users. That is, after receiving information like transaction details and receive addresses from the key device 112, the wallet server 126 communicates the information, along with guidance about how to safely verify it, to a user via communication channels like email, a webpage, or even one to one of their trusted contacts through the recovery module (discussed later). In one example, the guidance can also include flags in case the wallet server detects potential malware or other attack feature introduced by the edge devices.

FIG. 2 is a block diagram of a non-limiting example environment 200 showing operation of devices associated with the first entity 104 of FIG. 1 in greater detail in accordance with one or more implementations. The non-limiting example environment 200 is operable to implement security mechanisms using cryptographic keys in support of a digital wallet as described herein according to an implementation of the present subject matter.

Implementation of a digital wallet is achieved in this example through use of the first wallet application 118, the key device 112, and a wallet server 126. Each of these entities includes a respective cryptographic key that is usable to authorize a resource transfer using a multi-party computation (MPC) security technique. The key device 112, for instance, includes a hardware key 122 as previously described. The first wallet application 118 includes an application key 202 and the wallet server 126 includes a wallet server key 204.

The three parts of the digital wallet have different permissions and are optionality built-in to allow the first entity 104 to use self-serve tools in a way that fits with corresponding desires and supports variation across different geographic settings. The first wallet application 118 is operable as a mobile application executed on the first edge device 110 (e.g., a mobile phone of the first entity 104) that outputs a user interface to enable the first entity 104 to safely own and manage cryptographic tokens, while finding partners in order to buy/sell/convert between fiat currencies and cryptographic currencies.

In an implementation, the wallet server 126 further includes functionality of a decentralized service provider that runs as a node that peers directly with a node that is executed as part of a digital wallet on an edge device. The wallet server 126 is configured to route payments on the entity's behalf through the decentralized network 102 of FIG. 1, e.g., a blockchain network. Accordingly, the wallet server 126 may be executed as part of the decentralized network 102 or separately by a third-party system. Signing and transaction features are implemented by the wallet server 126.

The key device 112 is implemented to add additional layers of security as part of the digital wallet. The key device 112, for instance, includes a sensor 206 that is configured to receive inputs that are usable to uniquely identify the first entity 104, e.g., via biometric inputs, spoken utterance, a PIN a fingerprint scanner, palm reading, eye reading, and so forth. Inputs received via the sensor 206 are used by a control module 208 to permit or restrict access to the hardware key 122 maintained in the storage device 124. The control module 208 also includes recovery capabilities 210, e.g., in case the first entity 104 loses the first edge device 110 and therefore access to the first wallet application 118.

The key device 112, for instance, can be configured to prove ownership of corresponding hardware (e.g., the first edge device 110) which is then usable to provision the application key 202 and first wallet application 118 on the first edge device 110. A fingerprint sensor, for example, of the key device 112 is usable to authenticate the identity of the first entity 104. Authentication is performed in this instance before the key device 112 interacts with a near-field-communication (NFC) field of the first edge device 110 to sign a transaction with the application key 202 in the first wallet application 118. In another example, a PIN is entered using the first wallet application 118 and is then communicated using NFC to the key device 112 to unlock the device.

The digital wallet secures funds through use of the application key 202, the wallet server key 204, and the hardware key 122. In a multi-party computation (MPC) (e.g., “two-of-three”) security mechanism, two out of the three keys are utilized to permit a fund transfer as part of a transaction, i.e., by signing the transaction. This security mechanism is enforced by the decentralized network 102. Access to these keys is protected by corresponding access mechanisms. For the application key 202, for instance, access is protected through access techniques used to access the first edge device 110 itself and may also include a PIN or passphrase.

For the hardware key 122, access is protected through use of the sensor 206 and control module 208, e.g., using biometric techniques of the key device 112 in which data identifying the first entity 104 is maintained locally and not exposed outside of the device. For the wallet server key 204, this key is maintained by a wallet server 126, e.g., by a third party separate from the first entity 104. Consequently, as a “two-of-three” security mechanism, transfers of cryptographic tokens as part of a digital transaction are permitted without the wallet server 126 and corresponding wallet server key 204 through use of the application key 202 and the hardware key 122.

In an example of a transaction involving a relatively small amount of funds, a transaction is initiated by the first wallet application 118, which is then signed by the wallet server key 204. As such, the first entity 104 is able to perform the transaction while keeping the key device 112 “safely tucked away” as reserved for the recovery capabilities 210 and/or for relatively larger transactions, e.g., above a transaction limit as set by the first wallet application 118 and enforced by the wallet server 126.

Access to the hardware key 122 in the key device 112 is protected (e.g., by biometric data or PIN) and acts as but one part of the digital wallet. Another part of the digital wallet is implemented by the first wallet application 118. Both the first wallet application 118 and the key device 112 are configurable to work together in physical proximity (e.g., via NFC) to move larger amounts of funds, e.g., an amount that is over a transaction limit.

The digital wallet is also configurable to specify that both the first wallet application 118 and application key 202 as well as the key device 112 and hardware key 122 are to be used for each transaction, regardless of size, for additional security. On the other hand, the digital wallet is also configurable to permit any size of transaction without use of the key device 112. The key device 112 in this scenario is then used to recover keys in case the first edge device 110 and corresponding first wallet application 118 are lost through use of the recovery capabilities 210.

Through use of the multi-party computation (MPC) (e.g., “two-of-three”) security mechanism, a third party (e.g., associated with the wallet server 126) is not able to transfer funds, rather the first entity 104 is given true ownership as having two of the three keys. The wallet server key 204 is usable by the wallet server 126 to cooperate in wallet recovery (e.g., in case the first edge device 110 or key device 112 is lost) or sign transactions initiated by the first wallet application 118 and signed using the application key 202.

If the first edge device 110 is lost, the digital wallet is recoverable using the first wallet application 118 as executed on a new edge device and the key device 112. The first entity 104, for instance, unlocks the key device 112 using a fingerprint or PIN to expose the hardware key 122. If the key device 112 is lost (alone or along with the first edge device 110), the digital wallet is recoverable based on security settings defined by the first entity 104 when setting up the digital wallet.

FIG. 3 is a block diagram of a non-limiting example environment 300 showing operation of devices associated with the first entity 104 of FIG. 1 including a key device and a first edge device in greater detail as generating transaction details and transmitting the transaction details in accordance with one or more implementations. FIG. 4 is a flow diagram depicting a step-by-step procedure 400 in an example implementation of operations performable by a processing device for accomplishing a result of entry of details of a digital transaction involving a transfer of cryptographic tokens by a key device and transfer of those details to a wallet server. The following discussion refers, interchangeably, to FIGS. 3 and 4.

To begin in this example, an address is generated by a key device to enable transfer of one or more cryptographic tokens as part of a digital transfer (blocks 302, 402). An entity, for example, interacts with a key device 112 (e.g., a hardware key device) and enters details of a digital transaction that is to involve transfer of one or more cryptographic tokens, e.g., to be received by the entity or transferred from the entity. The details may include an address that is to participate in the digital transaction, amount of cryptographic tokens involved in the transaction, and so forth.

To do so, for instance, the first entity 104 is authenticated for access to the key device 112 (e.g., using sensors 206) to provide credentials such as to input a password, biometric data, spoken utterance, and so forth. Once authenticated. The first entity 104 interacts with a hardware input device disposed on the key device 112 (e.g., using sensors 206) to input the address as an intended participant in a digital transaction involving cryptographic tokens. Once entered, the address is signed (blocks 304, 404) by a hardware key 122 (e.g., a private cryptographic key) of the key device 112 that is maintained securely in storage device 124 local to the key device 112 (e.g., encrypted) and not exposed “outside” of the key device 112.

The key device 112 is then configured to transmit the signed address (and other transaction details when applicable such as transaction amount) to the wallet server 126, which may be performed directly and indirectly via the first edge device 110 (block 306). In an example in which the transmission is performed to the first edge device 110, the signed address is received from the key device 112 at the first edge device 110 associated with the key device 112 (block 406), e.g., using near field communication. The first edge device 110 and the key device 112 are “paired” in this example to implement secure communication between the two devices, e.g., using encrypted communications.

In an implementation, inputs are received at the first edge device 110 through execution of a wallet application 118 that specifies a supplemental interface 114 that is to be used to confirm the details. The supplemental interface 114, for instance, is selectable via a user interface using a dropdown menu as illustrated in FIG. 9 or other functionality, e.g., an IP address or other “pairing” technique. As a result, the first entity 104 is given a degree of control as to “how” confirmation of the transfer of cryptographic tokens as part of the digital transaction is performed. The transaction details, including the signed address and the supplemental interface identifier (ID) are then transmitted by the first edge device 110 to the wallet server 126 via the network 128, which may also be secured using cryptographic techniques to protect against compromise by malicious parties.

A determination is then made by the first wallet application 118 of the first edge device 110 as to whether a supplemental interface ID is received (decision block 408). If so (“yes” from decision block 408), the supplemental interface ID is included as part of a communication to be transmitted to the wallet server 126. If not (“no” from decision block 408) or in an instance in which the supplemental ID has been added to the transmission (block 410), the transmission is transmitted by the first wallet application 118 executed on the first edge device 110 to the wallet server 126 (block 412). Accordingly, in these examples the details of the digital transaction (e.g., the signed address) are then transmitted by the first wallet application 118 at the first edge device 110 to a wallet server 126. Other implementations are also contemplated in which the key device 112 transmits the signed address and other details of the digital transaction directly to the wallet server 126. The wallet server 126 then continues processing of the transaction as further described in the following example and shown in corresponding figures.

FIG. 5 is a block diagram of a non-limiting example environment 500 showing receipt by a wallet server of the transaction details of FIG. 3 and initiation of a transfer of cryptographic tokens as part of a digital transaction responsive to confirmation by a supplemental interface in accordance with one or more implementations. FIG. 6 is a flow diagram depicting a step-by-step procedure 600 in an example implementation of operations performable by a processing device for accomplishing a result of initiation of a transfer of cryptographic tokens responsive to receipt of a confirmation from a supplemental interface in accordance with one or more implementations. The following discussion refers, interchangeably, to FIGS. 5 and 6.

The wallet server 126, upon receipt of the transmission (e.g., from the first edge device 110 and/or the key device 112), is configured to verify whether the signed address originated from the key device 112 (block 502, decision block 602).

To do so, the wallet server 126 checks as to whether the signed address is signed with the private key of the key device 112 based on a comparison with a public key of the key device 112. If verification fails (“no” from decision block 602), a cancellation is returned (block 604) by the wallet server 126 to the first edge device 110 and/or the key device 112.

If the verification succeeds (“yes” from decision block 602), the wallet server 126 establishes a communication with the supplemental interface 114 associated with the edge device (block 504, block 606). Continuing with the previous examples, the communication is transmitted based on identification of the supplemental interface 114 at the first edge device 110, through association with an account of the first entity 104 maintained at the wallet server 126 (e.g., in support of direct communication between the key device and the wallet server), and so forth. The wallet server 126, for instance, may maintain a user account associated with the first entity 104. The user account includes a listing of supplemental interfaces that have been verified, through interaction with the first entity 104, as being permitted to confirm the transaction.

The supplemental interface 114 then displays the communication (block 506) in a user interface. The communication includes a representation of the address that is to receive the cryptographic tokens, an amount of the cryptographic tokens, and so forth. The user interface also includes an option 508 that is selectable to generate a confirmation to authorize the transfer (block 608). Selection of the option 508 causes the supplemental interface 114 to communicate the confirmation back to the wallet server.

The wallet server 126 receives the confirmation from the supplemental interface 114 (block 510, block 610), and in response, initiates the transfer of the cryptographic tokens (block 512) as part of the digital transaction using the address and other details (block 612) e.g., through interaction with the decentralized network 102 such as a blockchain. In this way, the supplemental interface 114 is configurable to address the previously described technical challenges and protect against compromise by malicious parties.

FIG. 7 is a block diagram of a non-limiting example environment 700 showing generation of transaction details on an edge device and confirmation of the details by a supplemental interface for initiating a digital transaction involving a transfer of cryptographic tokens accordance with one or more implementations. FIG. 11 is a flow diagram depicting a step-by-step procedure 1100 in an example implementation of operations performable by a processing device for accomplishing a result of initiation of a transfer of cryptographic tokens responsive to receipt of a confirmation from a supplemental interface responsive to generation of the transaction details by an edge device in accordance with one or more implementations. The following discussion refers, interchangeably, to FIGS. 7 and 11.

In these additional examples, a supplemental interface 114 associated with a key device 112 is also used in support of a digital wallet to perform a digital transaction. However, in this scenario the transaction details are entered at an edge device, confirmed by a supplemental interface, and once confirmed the edge device causes a key device to perform the transaction.

Proposed transaction details, for instance, are entered in a user interface of a first wallet application 118 (block 1102) executed by a first edge device 110. FIG. 8 depicts an example implementation 800 showing output of a user interface 802 by the first edge device 110 in support of entry of transaction details accordance with one or more implementations. The user interface 802 includes options to initiate a digital transaction, including an address that is to participate in the digital transaction and an amount. The user interface 802 further includes an option 804 that is user selectable via an input received thru the user interface 802 to verify transaction details on a supplemental interface.

A supplemental interface 114 is also selected via execution of the first wallet application 118 by the first edge device 110 to confirm the digital transaction (block 1104). FIG. 9 depicts an example implementation 900 showing output of a user interface 902 by the first edge device 110 in support of entry of a supplemental interface 114 that is to confirm transaction details in accordance with one or more implementations.

In this example, the user interface 902 is prepopulated with one or more supplemental interfaces that have been vetted through interaction with the first entity 104 for use in confirming a transaction. The user interface 902 includes options 904 including representations of the supplemental interfaces that are selectable to specify “which one” is to be used for confirmation in this particular instance, thereby further protecting against compromise by malicious parties. Accordingly, the user interface 902 supports inputs received via the first entity 104 to select a particular supplemental interface to be used for confirmation.

Returning again to FIG. 7, the first edge device 110 sends proposed transaction details to the wallet server 126 (block 702, block 1106) via the network 128. The wallet server 126 is then configured to send the transaction details to the supplemental interface 114 (block 1108) specified by the first edge device 110, e.g., to the first entity 104 or trusted contact via a custom webpage, email, or message (block 704). For example, the wallet server can generate a link to share with an intended recipient, e.g., edge device, to view the receive address and confirm that the address is correct.

FIG. 10 depicts an example implementation 1000 showing output of a user interface 1002 by a supplemental interface 114 as displaying transaction details and an option 1004 that is user selectable by the first entity 104 to confirm transaction details accordance with one or more implementations. The supplemental interface 114 displays the transaction details in a user interface 1002, which includes an address and an amount.

The user interface 1002 further includes an option 1004 that is user selectable to confirm the transaction details. The first entity 104 that is associated with the supplemental interface 114 (e.g., or trusted contact), for instance, views the proposed transaction details via the user interface 1002 and, if accurate, confirms the details through selection of the option 1004. The user interface 1002 also includes an option “I need help” that is selectable to surface additional information involving the digital transaction, how the transaction is to be implemented, and so forth.

Returning again to FIG. 7, a determination is made at the wallet server 126 as to whether the supplemental interface 114 has confirmed the transaction details (decision block 1110). If the confirmation is not received (“no” from decision block 1110), a cancellation is returned by the wallet server 126 (block 1112) to the edge device 112. If the confirmation is received (“yes” from decision block 1110), the web server then generates a signed authorization confirming the transaction details (block 706, block 1114). The signed authorization is then returned by the wallet server 126 to the first wallet application 118 (block 708, block 1116) executed by the first edge device 110. In this illustrated example, the first edge device 110 forwards the signed authorization to the key device 112 (block 710, block 1118), e.g., via near field communication (NFC).

Once the key device 112 receives the authorization and verifies the authorization was sent from the web server (e.g., through public/private key verification), the key device 112 enables completion of the digital transaction to transfer the cryptographic tokens (block 1120). The key device 112, for instance, supports user interaction with the first entity 104 to enable the key device 112 to sign an authorization to complete the transaction (block 712). Thus, in this example a supplemental interface is used to confirm entry by a wallet application which is then used to initiate a transfer by a key device. Other examples are also contemplated.

FIG. 12 is a non-limiting example 1200 showing operation of a blockchain node 1204 as part of a blockchain system 1202 as an example of a decentralized network 102 of FIG. 1 in accordance with one or more implementations. The blockchain system 1202 implements a virtual machine 1206 that is representative of a diverse range of functionality made possible by leveraging a blockchain. In a first such example, the virtual machine 1206 implements a 1208 of accounts 1210 and associated balances 1212 of those accounts 1210. Distributed ledgers 1208 support secure transfer of digital assets (e.g., tokens or coins of cryptocurrencies) between accounts 1210. The secure transfer is performable without management by a central authority through storage (illustrated as storage 1214) by blockchain nodes 1204 implementing a blockchain 1216 of the blockchain system 1202 as part of transaction data 1218. The transaction data 1218 is maintained as part of blocks 1220 (and associated block IDs 1222) of the blockchain 1216.

Through synchronized and distributed access supported by the blockchain 1216, changes to balances 1212 (e.g., a number of tokens) are visible to any entity with access to the blockchain 1216. Techniques are also implemented to support management of the balances 1212 across the accounts 1210, e.g., to enforce rules that a respective account 1210 does not transfer more tokens than are available based on a balance 1212 specified for that account 1210.

In another example, the virtual machine 1206 implements a distributed state machine 1224 that supports execution of a decentralized web application 1226. The distributed state machine 1224 is implemented along with the transaction data 1218 within the blocks 1220 of the blockchain 1216 such that the blocks 1220 describe accounts and balances as described above for the distributed ledge 1208. The transaction data 1218 also supports a machine state, which can change from block to block of the blockchain 1216. In one example, the decentralized web application 1226 is executable as part of a “Turing-complete” decentralized virtual machine that is distributed across the blockchain nodes 1204 of the blockchain. As Turning-complete, the decentralized web application 1226 is computationally universal to perform computing device operations, e.g., logic or computing functions. Thus, the decentralized web application 1226 is executable by a processing system as software that is storable in a computer-readable storage medium of the blockchain nodes 1204 to perform a variety of operations.

An example of the decentralized web application 1226 is executable automatically and without user intervention (or with partial human interaction wherein desired) by the blockchain nodes 1204 of the distributed state machine 1224. Execution of the decentralized web application 1226 includes obtaining data from a specified data source (e.g., devices, APIs, and so forth that are accessible via the network 128), and based on the data, initiating one or more operations based on conditions described in the decentralized web application 1226.

In order to publish blocks for addition to the blockchain 1216, a blockchain node 1204 may be implemented as a “miner” to add a block of transactions to the blockchain 1216. In one or more implementations, other blockchain nodes 1204 may communicate transactions received at those nodes to one or more mining nodes for validation. Mining nodes may perform peer-to-peer computations to check if transactions intended for the blockchain 1216 are valid and, if validated, may add validated transactions to a block 1220 that those blockchain nodes are building. If the transactions are determined to be valid, for instance, then the transaction data 1218 describing those transactions is encoded in or otherwise stored on a respective block 1220, which is linked to the blockchain 1216 such that the new block is “at the end” or “at the top” of the blockchain 1216, e.g., through inclusion of a hash of a previous block in the chain.

The blockchain nodes 1204 then broadcast this transaction history via the decentralized network 102 for sharing with other blockchain nodes. This acts to synchronize the blocks 1220 of the blockchain 1216 across the distributed architecture of computing devices. A variety of “types” of blockchain nodes 1204 may be used to implement the blockchain 1216. By way of example, the blockchain 1216 may be implemented at least in part using “full” blockchain nodes, which are nodes that store an entirety of the blockchain 1216, e.g., locally in computer-readable storage media of respective computing devices of the blockchain nodes. Other types of blockchain nodes may also be employed to implement additional functionality, such as for governing voting events, execution of protocol operations, rules enforcement, and so forth.

The blockchain 1216 may be leveraged to provide a diverse range of functionality. Due in part to the distributed storage and updating of the blockchain 1216 over the blockchain network, the blockchain 1216 may store its data in a decentralized manner, without a centralized database (e.g., run by a clearinghouse), and thus operate as a distributed ledger. The decentralized storage of the blockchain 1216 overcomes one of the disadvantages of centralized storage, which is that centralized storage essentially has a single point of failure. It is to be appreciated that in one or more implementations, the blockchain 1216 may be public (e.g., like Bitcoin and Ethereum blockchains), such that transactions on the blockchain 1216 are generally viewable with a connection to the Internet. Alternatively, the blockchain 1216 may be configured as a private blockchain, in one or more implementations. When the blockchain 1216 is a “private” blockchain, the computing devices used to implement the blockchain nodes may be controlled by a centralized authority, such as a company or a consortium of entities.

The blockchain 1216 supports the secure transfer of digital assets, such as the transfer of cryptographic tokens for a cryptocurrency. Often, cryptocurrencies (e.g., coins of the cryptocurrency) are the native assets to blockchains, whereas tokens are created “on top” of these blockchains. By way of example, the Bitcoin blockchain's native asset is (Bitcoin or “BTC”), a cryptocurrency. In one or more implementations, the blockchain network corresponds to the Bitcoin blockchain. In variations, however, the blockchain network may correspond to a different blockchain network (e.g., the Ethereum blockchain) or a combination of blockchain networks. It is to be appreciated that the described techniques may be used to optimize routing within a decentralized network (e.g., the decentralized network 102) for various digital instruments, including, by way of example and not limitation, cryptocurrencies (e.g., Bitcoin (BTC), Ether (ETH), Ripple (XRP), etc.) and tokens (e.g., non-fungible tokens (NFTs), smart contracts, digital rights management (DRM) mechanisms associated with digital content, mechanisms for shipping and logistics, etc.).

FIG. 13 is a non-limiting illustration of an example system 1300 that is operable to implement blockchain supported resource transfer communication protocol techniques described herein in accordance with one or more implementations. The illustrated system 1300 includes the first edge device 110 and first wallet application 118, the second edge device 116 and a second wallet application 120, a blockchain system 1302 as corresponding to the blockchain 1216 of FIG. 12, an identity hub 1304, and an institutional system 1306 (e.g., in support of performing a fund transfer of a transaction by a transaction server) that are communicatively coupled, one to another, via the network 128.

In accordance with the described techniques, the system 1300 implements a communication protocol 1308 configured to provide blockchain support for resource transfer in this example, i.e., to transfer funds as part of a transaction. The communication protocol 1308 incorporates various components, including decentralized identifiers and credentials as well as a schema 1310. Examples of the decentralized identifiers include first and second decentralized identifiers 1312, 1314 as managed by the first and second wallet applications 118, 120, respectively. Additionally, examples of the credentials include first and second verifiable credentials 1316, 1318 as also managed by the first and second wallet applications 118, 120, respectively.

The communication protocol 1308 facilitates the formation of mutual trust between parties involved in a message transfer that is not centrally controlled. Mutual trust is implemented, for instance, through direct trust negotiation between the parties, use of mutually trusted third-party systems to “vouch” for the parties, and so forth. The communication protocol 1308 is configurable in an example to implement trust in a manner that differs from conventional decentralized exchange protocols in that the model is not trustless. The communication protocol 1308, for instance, is configurable to employ decentralized trust through a public key infrastructure (PKI) that is usable to secure communication between entities, e.g., the first and second edge devices 110, 116, the institutional system 1306, and so forth. The communication protocol 1308 is built upon the decentralized identifiers used by the first and second edges devices 110, 116 as well as other entities in the system 1300, e.g., the institutional system 1306. Decentralized identifiers in this example support verifiable, decentralized digital identity.

As such, decentralized identifiers are configurable to refer to a variety of different entity types (e.g., a user, organization, institution, data model, thing, abstract entity, and so forth) as determined by a controlling entity of the decentralized identifier. This is in contrast to typical federated identifiers, in that decentralized identifiers are decoupled from centralized registries, identity providers, and certificate authorities. For example, while other parties may be used to enable information discovery related to a decentralized identifier, this configuration supports an entity which is associated with a decentralized identifier control over the identity associated with the decentralized identifier without involving permission from another entity. Decentralized identifiers (DIDs) are configurable as uniform resource identifiers (URIs) that associate a DID subject with a DID document, thereby supporting trustworthy interactions associated with that subject. Examples of the decentralized identifiers include a first decentralized identifier 1312 associated with the first wallet application 118 and a second decentralized identifier 1314 associated with the second wallet application 120. Decentralized identifier (DID) documents, which are linked to the decentralized identifiers, are configurable as a metadata file that includes a variety of data elements, examples of which include cryptographic material and routing endpoints. Cryptographic material is usable by an entity that is associated with the decentralized identifier to provide control, e.g., through use of public keys, digital signatures, and so forth. Routing endpoints specify locations, at which, data with an entity that is associated with the decentralized identifier is exchanged and/or at which the entity is contacted. The routing endpoints, for instance, specify an identity hub 1304 having associated personal data storage and relay nodes used by a data store and message relay system 1320. Decentralized identifier techniques are implemented by the communication protocol 1308 in a variety of ways. Examples include use of a communication protocol 1308 that is open, public, and permissionless, and is tamper resistant. Further, the communication protocol 1308 produces a record that is probabilistically finalized and independently, deterministically verifiable, even in the presence of segmentation, state withholding, and collusive node conditions. Further, the communication protocol 1308 is not reliant on authorities, trusted third parties, or entities that cannot be displaced through competitive market processes.

Credentials are also used as part of the communication protocol 1308, examples of which include the first and second verifiable credentials 1316, 1318. These credentials are configured as cryptographically secure, respect privacy, and are machine verifiable. In one implementation, inclusion of a zero-knowledge proof is usable to further advance privacy and safety by preventing an ability to link across disclosures, reduces an amount of data that is discoverable, and reduces raw data value exposure.

The system 1300 is also configurable to include a variety of additional entities that are involved as part of the communication protocol 1308, examples of which are illustrated as a blockchain system 1302 implementing a virtual machine 1206 and an identity hub 1304 implementing the data store and message relay system 1320.

The identity hub 1304 provides an interface, through which, to store, discover, and fetch data related to communications involved in a request (e.g., transaction involving a funds transfer) supported by the communication protocol 1308. The data store and message relay system 1320 of the identity hub 1304, for instance, is usable to locate public or permissioned private data related to a particular decentralized identifier, e.g., the first and second decentralized identifiers 1312, 1314. The identity hub 1304 is configurable as having a mesh-like datastore construction that supports an ability of an entity to operate multiple instances that synchronize to a same state across one another. Use of the mesh-like datastore construction provides an entity that is associated with the decentralized identity with an ability to secure, manage, and transact data with other entities without reliance on location or provider-specific infrastructure, interfaces, or routing mechanisms.

The identity hub 1304 supports use of a semantic message 1322 and respective data interfaces (e.g., as inferential application programming interfaces (APIs)) in accordance with the schema 1310 that are accessible without direct knowledge of a semantic type of data that is to be exchanged. A diverse set of interactions and flows are modeled within these interfaces as part of the schema 1310 by externally codifying sets of message schemas and processing directives to form respective protocols.

The semantic message 1322 employs the schema 1310 as supporting a naming convention of the datatypes of objects included in the message. Configuration of the semantic message 1322 enables entities that receive the semantic message 1322 to readily parse the message using the schema 1310, e.g., to determine whether the semantic message 1322 is of interest to the entity and process it accordingly. As such, the schema 1310 of the semantic message 1322 helps support the distributed architecture of the communication protocol 1308. For example, the identity hub 1304 is configured to identify, through semantics of the message, and process/forward the semantic message 1322 to a respective institutional system 1306 which can then also process the semantic message 1322 based on the schema. In one example, the semantic messages 1322 are signed by each entity through the process by the schema 1310 as part of a point-to-point messaging protocol 1324.

Digital wallets act as agents for individuals or institutions by facilitating exchanges with the institutional system 1306 or other third-party service provider system. As such, digital wallets are configurable to support a variety of functionalities. The first and second wallet applications 118, 120, for instance, support secure encrypted storage for verifiable credentials as illustrated, e.g., the first and second verifiable credentials 1316, 1318 for the blockchain system 1302. The first and second wallet applications 118, 120 also support discovery of an institutional system 1306 or other third-party service provider system by crawling the identity hub 1304. The first and second wallet applications 118, 120, further include mechanisms for receiving, offering, and presenting verifiable credentials used as part of the communication protocol 1308. Yet further, the first and second wallet applications 118, 120 implement digital signature mechanisms and support an ability to store a transaction history. The first and second wallet applications 118, 120 are configurable to support seamless transfer of credentials between wallets, and as such does not claim “ownership” of verifiable credentials. Additionally, operation of the first and second wallet applications 118, 120 is consent driven by an entity associated with the digital wallet.

The communication protocol 1308 includes a plurality of communication layers, an example of which includes a point-to-point messaging protocol 1324. The point-to-point messaging protocol 1324 is used to implement secure communication between the first and second wallet applications 118, 120, and the institutional system 1306, e.g., to exchange data used to obtain and receive decentralized identity data.

The semantic messages 1322 exchanged between the first and second wallet applications 118, 120 and institutional system 1306 (e.g., using the data store and message relay system 1320 of the identity hub 1304) contains semantically defined objects adherent to the schema 1310. The message objects also contain data usable by the entities to evaluate requests, verify credentials, and execute value exchanges. The semantic message 1322 is configurable as a JavaScript Object Notation (JSON) object, which is signed by each entity from a sending entity to the receiving entity for each segment of the resource transfer. The semantic message 1322 is encrypted in one example and employs programming hooks that enable a message handler service to receive the semantic message 1322 in real time at the identity hub 1304 and process the messages as part of a data store and message relay system 1320 in accordance with the semantics and rule set by the communication protocol 1308 and schema 1310 that are defined for a given message type. In this way, the identity data exchange is secured.

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method comprising:
generating, by a key device, an address to enable transfer of one or more cryptographic tokens as part of a digital transaction;
signing, by the key device, the address for authorizing the transfer;
receiving the signed address by a wallet application executing on an edge device associated with the key device;
verifying, by the wallet server, that the signed address received via the wallet application originated from the key device;
establishing, by the wallet server, a communication based on the address for receipt by a supplemental interface associated with the edge device;
displaying, by the supplemental interface, the communication having an option that is selectable to generate a confirmation to authorize the transfer;
receiving, by the wallet server, the confirmation from the supplemental interface that the transfer of the one or more cryptographic tokens is permitted; and
initiating, by the wallet server, the transfer of the one or more cryptographic tokens using the address responsive to the receiving of the confirmation.

2. The method of claim 1, wherein the key device is a wallet hardware key device that is displayless.

3. The method of claim 2, wherein the wallet hardware key device includes one or more sensors usable to verify access of an entity to a cryptographic key maintained locally in storage that is usable to sign the address for authorizing the transfer.

4. The method of claim 1, wherein the verifying by the wallet server employs a public key associated with a private key used by the key device to sign the address.

5. The method of claim 1, wherein the displaying includes displaying the address and an amount involved in the transfer of the one or more cryptographic tokens as part of the digital transaction in a user interface along with the option that is user selectable to cause generation of the confirmation and transmission of the confirmation back to the wallet server.

6. The method of claim 1, further comprising displaying a user interface at the edge device that is configured to specify the supplemental interface that is to receive the communication.

7. The method of claim 6, wherein the displaying of the user interface at the edge device further includes displaying the address that is to participate in the transfer of the one or more cryptographic tokens as part of the digital transaction.

8. The method of claim 6, wherein the user interface includes representations of a plurality of supplemental interfaces that are permitted to receive the communication.

9. The method of claim 8, wherein the plurality of supplemental interfaces is associated with a user account of an entity that is to participate in the digital transaction.

10. The method of claim 1, wherein the transfer of the one or more cryptographic tokens as part of the digital transaction is performed using a blockchain.

11. A wallet server comprising:
a processing device; and
a computer-readable storage medium storing instructions that, responsive to execution by the processing device, causes the processing device to perform operations including:
receiving a signed address from an edge device, the signed address signed by a key device associated with the edge device to enable transfer of one or more cryptographic tokens as part of a digital transaction;
verifying that the signed address originated from the key device;
establishing a communication based on the address for receipt by a supplemental interface;
receiving a confirmation from the supplemental interface that the transfer of the one or more cryptographic tokens is permitted; and
initiating the transfer of the one or more cryptographic tokens as part of the digital transaction using the address responsive to the receiving of the confirmation.

12. The wallet server of claim 11, wherein the operations further comprise receiving an identifier of the supplemental interface that is to confirm the transfer of the one or more cryptographic tokens as part of the transaction.

13. The wallet server of claim 11, wherein the operations further comprise identifying the supplemental interface based on a user account maintained at the wallet server, the user account associated with an entity that is to participate in the digital transaction.

14. The wallet server of claim 11, wherein the verifying is performed using a public key associated with a private key maintained as a cryptographic key at the key device.

15. The wallet server of claim 11, wherein the key device is a wallet hardware key device that includes one or more sensors usable to verify access of an entity to a cryptographic key maintained locally in storage that is usable to sign the address for authorizing the transfer.

16. A method comprising:
receiving, by a wallet server, transaction details from an edge device that are proposed for a transfer of one or more cryptographic tokens as part of a digital transaction;
forming, by the wallet server, a communication for display by a supplemental interface associated with an address that is to participate in the transfer;
receiving, by the wallet server, a confirmation from the supplemental interface that the transfer of the one or more cryptographic tokens is permitted;
generating, by the wallet server, a signed authorization confirming the transaction details using at least one cryptographic key; and
transmitting, by the wallet server, the signed authorization for receipt by a key device that is configured to determine that the signed authorization originated from the wallet server and is configured to participate in the transfer as part of the digital transaction.

17. The method of claim 16, wherein the transmitting includes transmitting the signed authorization for receipt by the edge device, the signed authorization configured to cause the edge device to communicate the signed authorization for receipt by the key device.

18. The method of claim 16, wherein the transaction details identify the supplemental interface.

19. The method of claim 16, wherein the transaction details are entered through interaction with the key device and transmitted by the key device to the edge device for communication to the wallet server.

20. The method of claim 16, wherein the signed authorization is transmitted to the edge device for subsequent communication to the key device.
